(19) United States
(12) Patent Application Publication
(10) Pub. No.: US 2009/0018178 A1
(43) Pub. Date: Jan. 15, 2009

(54) USE OF HALOARYLPYRAZOLE COMPOUNDS IN THE CONTROL OF PARASITE INFESTATION ON ANIMALS

(75) Inventors: Christina Mertens, Boxmeer (NL); Heike Dohrmann, Schwabenheim (DE)

Correspondence Address: Intervet/Schering-Plough Animal Health;PATENT DEPARTMENT, PO BOX 318, 29160 Intervet Lane, MILLSBORO, DE, 19966-0318, US

(73) Assignee: AKZO NOBEL N.V., ARNHEM (NL)

(21) Appl. No.: 10/577,178

(22) PCT Filed: Nov. 3, 2004
(86) PCT No.: PCT/EP2004/052763

§ 371 Date: Apr. 26, 2006

(30) Foreign Application Priority Data
Nov. 4, 2003 (EP) 03078484.7

(51) Int. Cl. A01N 43/50; A01P 7/02

(52) U.S. Cl. 514/397

(57) ABSTRACT

The present invention relates to the use of haloarylpyrazoles as tick-repellent compositions, and to an administration regimen of specific haloarylpyrazoles for controlling ticks on animals.

The invention is related to the use of haloarylpyrazole compounds for deterring ticks and to an administration regimen of specific haloarylpyrazole compounds for the control of ticks on animals.

Repellents and deterrents have in general the task of deterring harmful or troublesome arthropods from contacting, stinging or feeding on areas that are attractive to them, such as the skin of animals. Because of this effect compounds with repellent activity can be used to prevent diseases caused or transmitted by such arthropods. Arthropods are in particular insects, mites and ticks.

Ticks belong to the order Acarina. The Ixodidae and Argasidae species of ticks are of most economic importance and include the important species Boophilus spp., Rhipicephalus spp, Ixodes spp, Hyalomma spp., Amblyomma spp., Haemaphysalis spp., Derinacentor spp., Anocentor spp., Rhipicentor spp., Margaropus (Ixodidae) and Argas spp., Otobius spp. and Ornithodoros spp. (Aragasidae), which preferably infest warm-blooded animals including livestock, such as cattle, pigs, sheep and goats, poultry such as chickens, turkeys and geese, fur-bearing animals such as mink, foxes, chinchillas, rabbits and the like, as well as companion animals such as cats, dogs and horses, but also humans.

Acarid infestation, i.e. infestation by ticks can cause significant economic loss in livestock due to poor quality hide, wool or sheep skin, poor quality meat/tissue, reduced weight gain, reduced milk production and even death as a result of the animal carrying ticks.

Ticks are responsible world-wide for the transmission and spread of many human and animal diseases. They are carriers of bacterial (e.g. rickettsial), viral and protozoal diseases and cause tick-paralysis and tick-toxicosis. Even a single tick can cause paralysis whereby its saliva penetrates into the host animal during ingestion.

Diseases caused by ticks are usually transmitted by ticks, which infest several host animals. Such diseases, for example babesiosis, anaplasmosis and theileriosis, are responsible for the death or impairment of a large number of domestic and farm animals in the entire world. In many countries of temperate climate, ixodide ticks transmit the agent of the chronically harmful Lyme's disease from wild animals to humans.

Although the harmful effects of a tick infestation on animals have been known for years, and enormous progress has been made using tick-control programmes, until now no completely satisfactory methods of controlling or eliminating these parasites have been found, and in addition, ticks have often developed resistance to chemical active ingredients.

Thus, there continues to be a need for control programs against acarid parasites, especially ticks which afflict companion animals and livestock and which are effective at low application rates, selective in biologic action and have low toxicity.

In EP 412849 certain aryl-1,2,3 triazoles and arylpyrazoles are disclosed in which the imidazol(in)e group is attached directly or indirectly through its 2-position to the triazole or pyrazole ring that have pesticidal activity. For certain of the compounds that are disclosed in European Patent No. EP 412849, systemic activity against ectoparasitic insects after oral application to an animal is described.

The efficacy of certain haloarylpyrazoles in the control of ticks (Boophilus and multi-host tick species) at a dosage of 7.5 to 15 mg/kg in host animals has been disclosed in Research disclosure 380, P802 (No 38028) “Extended Efficacy Spectrum of Azole Pesticides” Research disclosure 380, P802 (No 38028).

The current invention proposes to improve the processes for controlling acarid parasites, especially ticks in animals, especially in companion animals, in particular in dogs.

The invention thus relates in a first aspect to the use of haloarylpyrazole compounds of formula (I)

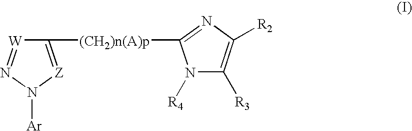

wherein
Ar is 2,6-dichloro-4-trifluoromethylphenyl or 2-nitro-4-trifluoromethylphenyl;

### A is S(O)ₘ, —CH═CH—, O or NH;

### W is N and Z is CR⁵; or W is CR¹ and Z is N or CR⁵;

R¹ is hydrogen, optionally substituted alkyl, halogen or R²⁰S(O)_{q};
R² and R³ are hydrogen, alkyl, alkenyl or alkynyl, each of which is optionally substituted, aryl, cyano, halogen, nitro, YR²⁰, S(O)₂NR⁸R⁹, CHO, NR⁸R⁹ or CYNR⁸R⁹;
R⁴ is hydrogen, optionally substituted alkyl, optionally substituted alkenyl, acyl or optionally substituted alkoxycarbonyl;
R⁵ is hydrogen, alkyl, optionally substituted amino or halogen;
R⁸ and R⁹ are the same or different and are hydrogen, optionally substituted alkyl, acyl or aryl;
R²⁰ is optionally substituted alkyl;

### Y is O or S;

m is 0, 1 or 2;
p is 0 or 1;
n is 0, 1 or 2; and
q is 0, 1 or 2,
and in which a) any alkyl, alkoxy and alkylthio groups is of 1 to 4 carbon atoms; b) any alkenyl or alkynyl groups is of 2 to 5 carbon atoms; c) any substituted alkyl, alkoxy, alkylthio, alkenyl or alkynyl group is substituted by one or more of the same or different groups selected from halogen, YR²⁰, dihalocyclopropyl, cyano, nitro, optionally substituted amino, acyloxy and aryl; d) any aryl group is phenyl, optionally substituted, by halogen, alkyl, haloalkyl, alkoxy, haloalkoxy, alkylthio, haloalkylthio, haloalkylsulphonyl, cyano or nitro; e) any acyl group is alkanoyl of 1 to 4 carbon atoms, or alkylsulphonyl or haloalkylsulphonyl; and f) any optionally substituted amino groups is of formula NR⁸R⁹, with the proviso that when W is CR¹ and Z is CR⁵ and n and p are both 0, R⁴ is not alkyl, for the manufacturing of a medicament for the treatment of tick infestation of animals by deterring ticks.

Haloarylpyrazole compounds of formula (I) have been described in EP 0412849. Methods for the preparation of these compounds are also disclosed in EP 0412849.

A prominent representative of an haloarylpyrazole compound of formula (I) to be used in the non-therapeutical process for deterring ticks is 5-chloro-1-(2,6-dichloro-4-trifluoromethylphenyl)-4-(4,5-dicyano-1H-imidazol-2-yl)-3-isopropyl-1H-pyrazole of formula (II):

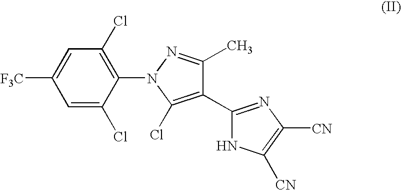

This compound is indicated as compound 22c in European Patent No. EP 0412849. The synthesis of this compound is disclosed in Example 22b of EP 0412849. In the remainder of this application this compound will be referred to as “compound 22c”.

Repellents and deterrents have the task of deterring harmful or troublesome arthropods from contacting, stinging or feeding on areas that are attractive to them, such as the skin of animals. It is the object of the current invention that this repellent effect can be reached by means of prior administration of the arylpyrazole compound to the host animals. The deterrent effect after administration of the compound results in anti-attachment and anti-feeding of the parasites, especially ticks. The deterrent (repellent) effect according to the current invention is shown in the example. A significant higher number of live, non-engorged ticks were found in the pens of dogs treated with a compound according to the invention compared to the environment of the control group.

The benefit of deterring ticks is that compounds are very effective against target parasites and at the same time of low toxicity for the warm-blooded host animals. This is because their activity is based not only on the death of the target parasite, but on the parrying defence thereof (as a repellent or as a deterrent), before it attaches, bites feeds or in any other way harms the host organism. The presence of the deterring (repellent) compounds appears to disturb the parasites in such a way that they suddenly leave the treated animal without attaching or feeding or even do not infest a treated host animal at all.

In an alternative embodiment the compounds of formula (I) can be used in a non-therapeutic process for deterring ticks from animals.

Preferably the compounds of formula (I) are administered systemically. Systemic administration is the administration of the composition to an animal at a site remote from the site where the parasite resides, so that the active compound gets in contact with the parasite along with the blood, body fluids or tissue such as e.g. skin of the host animal, and can then exhibit activity against the parasite. Systemic administration is e.g. orally, by injection, implant or by other means, for example trans-dermally by spot-on or pour-on, so that there is sufficient of the agent in the tissues or body fluids to kill the parasite feeding on the animal in the case of control or to deter the parasite.

The compound is preferably administered in an oral formulation. The term “oral formulation” means that active ingredients are formulated into a product or formulation suitable for administering to the animal via the mouth. These products or formulations include, but are not limited to tablets, capsules, liquids, gels, pastes, oral sprays, buccal formulations, powders, granules, chewable treats or animal feeds containing the active ingredient. Such formulations include pharmaceutically acceptable auxiliaries.

Pharmaceutically acceptable auxiliaries are known in the art and described in, for example, standard textbooks such as Remington: The science and Practice of Pharmacy, 20^{th} Edition (2000), Chapter 45. Solid oral formulations, e.g. conventional tablets generally comprise the active ingredients and a diluent to assist in increasing the powder mass to a convenient size and improve compressibility, a binder to hold the compressed powder together and a lubricant to assist in densification and ejection from the tablet die. They may also contain a disintegrate, to improve disintegration and dissolution as well as stabilizers, colours and flavours. Tablets are often coated to improve appearance or taste or to alter the dissolution properties. Tablets can be designed to dissolve fast or slow, and depending on the actual volume and compressibility of the drug, large or small. They can be made chewable or to dissolve under the tongue or in the pouch of the cheek.

Conventional liquid formulations are usually solutions, suspension or emulsions of the active ingredient together with suitable diluents, solvents, flavours and colours to form a palatable dosage form.

It has been found that compound 22c—5-chloro-1-(2,6-dichloro-4-trifluoromethylphenyl)-4-(4,5-dicyano-1H-imidazol-2-yl-3-methyl-1-H pyrazole of formula (II), is effective against ticks when systemically applied in a regimen that employs the administration of a initial dosage of 4 mg/kg bodyweight followed by weekly administrations of 2 mg/kg for improved control of ticks. This administration scheme was proven to be effective to control tick infestation of animals and is safe to the host animal. The initial dose of 4 mg/kg can also be split into two doses of 2 mg/kg given on two consecutive days.

The invention thus relates in a second aspect to the Use of 5-chloro-1-(2,6-dichloro-4-trifluoromethylphenyl)-4-(4,5-dicyano-1H-imidazol-2-yl-3-methyl-1-H pyrazole for the manufacturing of a medicament for the control of ticks for oral administration to animals in an initial dose of 4 mg/kg bodyweight of the animal followed by weekly administration of doses of 2 mg/kg bodyweight of the animal.

The compound 22c can be administered in such a regimen and as repellent to all species of animals that have tick infestation. The recipient of the composition may be a livestock animal e.g. sheep, cattle, pig, goat, a laboratory test animal, e.g. guinea pig, rat or mouse or, in particular, a companion animal e.g. dog, cat, rabbit, ferret or horse. Preferably the animal is a companion animal, more preferably a dog or cat. Especially preferred are dogs.

In general, the composition according to the invention will contain an effective amount of the active ingredients, meaning a non-toxic but sufficient amount to provide the desired control or deterring effect. Such an amount will depend on the age, condition, weight and type of the target animal.

### EXAMPLE

### Tick-Efficacy of Compound 22c

Two groups of 6 dogs each were infested with ticks (Rhipicephalus sanguineus) before and at different time points after treatment. Group I was treated orally with Compound 22c at a dose of 4 mg/kg bodyweight (bw) followed by 3 weekly doses of 2 mg/kg bw. Group II remained untreated as positive control.

The parasite burden of individual dogs was assessed 48 h, 72 h or 120 h after infestation by removing and counting of ticks. Ticks were classed according to vitality (dead/alive) and the parasitic status of ticks (engorged/unfed; attached/free).

### Materials and Methods

Study animals

### Species: Domestic dog

### Number: 12

Health status: The dogs were healthy at the start of the study as determined by a veterinarian on Day −2. None of the dogs had been treated with an acaricide/insecticide for at least 8 weeks prior to the study.

### Animal Housing

Study animals were kept indoors in individual pens with concrete floors and a special resting area allowing the collection of parasites from the environment. The study was carried out according to the existing guidelines for the “Testing and evaluation of the efficacy of antiparasitic substances for the treatment and prevention of tick and flea infestation in dogs and cats” (EMEA/CVMP/005/00) providing maximum comfort to the dogs under study conditions.

### Parasite Infestation

Dogs were experimentally infested with laboratory strains of Rhipicephalus sanguineus (50-100 unfed adults; sex ratio 1:1) as reflected in table 1. Ticks were directly applied onto the back of the animal. For the time of parasite distribution over the host the dogs were kept quiet by sedation.

Ticks of Rhipicephalus sanguineus were infested on day −2, day +5, day +12, day +16, and day +23.

### Product Specifications

### Investigational Product Compound 22c Tablet

| | |
|---|---|
| Investigational Product | Compound 22c Tablet |
| Active Ingredient: | Compound 22c 10.0% (w/w) |
| Dosage: | 4 mg/kg bodyweight-initial dose; 2 mg/kg |
| | bodyweight-maintenance dose, Application |
| | Per os |

### Treatment

Treatments followed the schedule as set out below:

| | Number | Investigational | | |
|---|---|---|---|---|
| Day | of dogs | veterinary product | Dose | Application |
| 0 | 6 | Compound 22c | 4 mg/kg bw | Per os |
| +7 | 6 | Compound 22c | 2 mg/kg bw | Per os |
| +14 | 6 | Compound 22c | 2 mg/kg bw | Per os |
| +21 | 6 | Compound 22c | 2 mg/kg bw | Per os |

### Route and Method of Administration

The investigational product was applied directly to the back of the tongue to induce swallowing. To calculate the doses body weights were used. The smallest unit that had been used was half a tablet. Tablets were not scored but were broken into even pieces. Where necessary the dose was rounded to the nearest half tablet. The administered doses were recorded.

### Assessments:

### Evaluation of Tick Numbers

Each assessment started with the dogs of the treatment group to prevent cross-contamination of treated dogs with ticks of the control group.

Tick assessments on the dogs were made on the day +2, day +7, day +14, day +21 and day +26. Tick counts were made 48 hours after the first treatment and 48 hours, 72 hours or 120 hours after re-infestation. For counting all ticks were removed from the animals and grouped into the following categories:

| | General | | |
|---|---|---|---|
| Category | findings | Attachment status | Effect |
| 1 | live | Free | no |
| 2 | live | attached-unengorged | no (except single ticks) |
| 3 | live | attached-engorged | no (except single ticks) |
| 4 | killed | Free | yes |
| 5 | killed | attached-unengorged | yes |
| 6 | killed | attached-engorged | no (except single ticks) |

### Evaluation of Repelled Ticks

To assess the number of repelled ticks due to treatment with compound 22c, live, unattached ticks were collected daily from the pens of the dogs after each infestation. The total number of collected ticks were determined on each assessment-day to determine the number of unattached (control dogs) and repelled ticks (treated dogs) for each group.

### Calculation of Efficacy

Efficacy calculation was based on the arithmetic means of number of ticks on treated dogs compared to the control group. For calculation of efficacy (%), the following formula (according to Abbot's formula) is used:

Efficacy=100×(m_{c}−mᵣ)/m_{c}
Control group (m_{c}): mean number of live ticks on the host animals
Treatment group (mᵣ): mean number of live (category 1-3) or killed, engorged ticks (category 6) on the host animal

The number of life, unattached ticks collected from the pens of both groups were statistically compared using the Pearson asymptotic and exact Chi-Square-Test to determine a repellent/deterrent effect. If the statistical evaluation showed significance for repellence, the free ticks collected from the pens were not considered for calculation of efficacy.

### Results

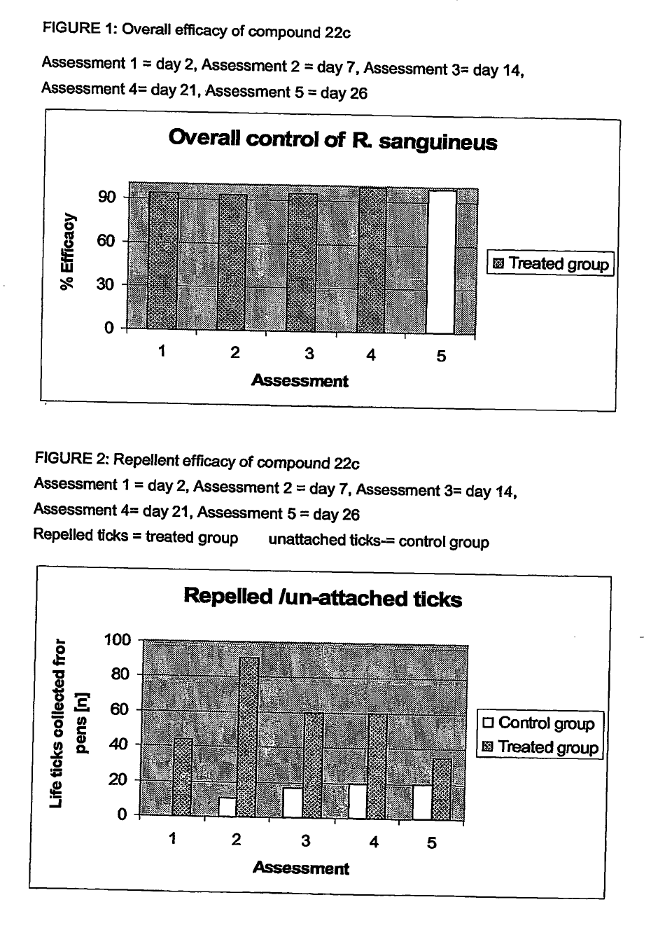

The overall efficacy against ticks (Rhipicephalus sanguineus) is given in FIG. 1. The repellence effect is given in FIG. 2.

### Efficacy Against Rhipicephalus Sanguineus

### Day +2

Each dog was infested with 50 Rhipicephalus sanguineus on day −2. On day 0 the initial dose of 4 mg/kg bw was applied to each dog of the treatment group. Ticks were assessed 48 hours after treatment and recorded.

44 live, non-engorged ticks were found in the pens of treated dogs whereas not a single live, free tick was found in the environment of the control group. Statistics strongly suggest a repellent effect of compound 22c (p<0.0001). Repellence is a parameter of control. The overall efficacy was 93.8%.

### Day +7:

Each dog was infested with 100 Rhipicephalus sanguineus on day +5 after treatment. 48 hours after infestation, the assessment was conducted as described.

As on day +2 after treatment, there was a significant difference of free, live ticks in the pens of treated dogs (n=91) versus free, live ticks collected from control pens (n=11). Repellence was highly significant (p<0.0001). The overall efficacy was 93.2%.

### Day +14:

Each dog was infested with 80 Rhipicephalus sanguineus on day +12 after the last treatment (d+7). 48 hours after infestation the assessment was conducted. As before, there was a significant difference (p<0.0001) of free, live ticks in the pens of treated dogs (n=60) versus free, live ticks collected from control pens (n=17) confirming the repellent hypothesis. All 60 live ticks collected from the pens of the treated group were visibly damaged indicating the ticks had been in contact with the drug but had not firmly attached but left the host. The overall efficacy was 94.6%.

### Day +21

Each dog was infested with 60 Rhipicephalus sanguineus on day +16; 48 hours after the last treatment (d+14). The tick assessment was conducted 120 hours after infestation (day +21). The time of assessment was extended to investigate if the efficacy increased when ticks were exposed to the drug for longer than 48 hours. As before, there was a significant difference (p<0.0001) of free, live ticks in the pens of treated dogs (n=60) versus free, live ticks collected from control pens (n=20) confirming the repellent hypothesis. 59 of the 60 live, free ticks of the treated group were visibly damaged indicating exposure to the drug without attaching firmly to the host. The overall efficacy was 99.4%.

### Day +26

Each dog was infested with 60 Rhipicephalus sanguineus on day +23, 48 hours after the last treatment (d+21). The assessment was conducted 72 hours after the infestation.

34 of the 35 live, free ticks collected from pens of the treated group were visibly damaged indicating that they had been efficiently repelled from the host (p<0.0001). The overall efficacy was 98.3%.

Overall, the Compound 22c showed prophylactic activity against ticks preventing attachment and feeding (repellence). Significant numbers of live but visibly damaged ticks were collected from the pens of treated dogs after each infestation indicating ticks failed to firmly attach to the host. Under natural challenge conditions this will be seen as a preventive effect against ticks.

Against Rhipicephalus sanguineus initial efficacy of 94% was reached within 48 hours after the first treatment. Challenge infestations 48 hours after dosing (day 16; day 23) were controlled in the range of 98-99%. Ticks infested 120 hours after the dosing (day 5; day 12) were controlled with 93-95%. For Rhipicephalus sanguineus, therapeutic tick control was achieved throughout the study (28 days) with the weekly dosing schedule. In conclusion, Compound 22c was highly efficacious against Rhipicephalus sanguineus.

Overall, Compound 22c applied at a weekly dose of 2 mg/kg bw after an initial dosage of 4 mg/kg bw was well tolerated and demonstrated an exceptional acaricidal potential as well as the potential to prevent attachment and feeding of ticks.

1) A method for deterring ticks from infesting an animal, wherein:
the method comprises administering a haloarylpyrazole to the animal;
the haloarylpyrazole corresponds in structure to formula (I): 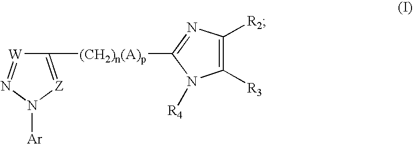
Ar is 2,6-dichloro-4-trifluoromethylphenyl or 2-nitro-4-trifluoromethylphenyl;
A is S(O)ₘ, CH═CH, O, or NH;
as to W and Z:
W is N, and Z is CR⁵; or
W is CR¹, and Z is N or CR⁵;
R¹ is hydrogen, optionally substituted alkyl, halogen, or R²⁰S(O)_{q};
R² and R³ are hydrogen, optionally substituted alkyl, optionally substituted alkenyl, optionally substituted alkynyl, aryl, cyano, halogen, nitro, YR²⁰, S(O)₂NR⁸R⁹, CHO, NR⁸R⁹, or CYNR⁸R⁹;
R⁴ is hydrogen, optionally substituted alkyl, optionally substituted alkenyl, acyl, or optionally substituted alkoxycarbonyl;
R⁵ is hydrogen, alkyl, optionally substituted amino, or halogen;
R⁸ and R⁹ are independently hydrogen, optionally substituted alkyl, acyl, or aryl;
R²⁰ is optionally substituted alkyl;
Y is O or S;
m is zero, 1, or 2;
p is zero or 1;
n is zero, 1, or 2;
q is zero, 1, or 2;
any alkyl, alkoxy, or alkylthio comprises 1 to 4 carbon atoms;
any alkenyl or alkynyl comprises 2 to 5 carbon atoms;
any alkyl, alkoxy, alkylthio, alkenyl, or alkynyl portion of a substituted alkyl, alkoxy, alkylthio, alkenyl, or alkynyl is substituted by one or more substituents independently selected from the group consisting of halogen, YR²⁰, dihalocyclopropyl, cyano, nitro, optionally substituted amino, acyloxy, and aryl;
any aryl is phenyl optionally substituted by halogen, alkyl, haloalkyl, alkoxy, haloalkoxy, alkylthio, haloalkylthio, haloalkylsulphonyl, cyano, or nitro;
any acyl is alkanoyl comprising 1 to 4 carbon atoms, alkylsulphonyl, or haloalkylsulphonyl;
any optionally substituted amino is NR⁸R⁹; and
R⁴ is not alkyl when:
W is CR¹,
Z is CR⁵, and
n and p are both zero.

2) The method according to claim 1, wherein the haloarylpyrazole is 5-chloro-1-(2,6-dichloro-4-trifluoromethylphenyl)-4-(4,5-dicyano-1H-imidazol-2-yl-3-methyl-1-H pyrazole.

3) The method according to claim 1, wherein the haloarylpyrazole is applied systemically to the animal.

4) The method according to claim 3, wherein the haloarylpyrazole is applied orally to the animal.

5) The method according to claim 1, wherein the haloarylpyrazole is applied as a tablet to the animal.

6) The method according to claim 1, wherein the animal is a dog or cat.

7) The method according to claim 1, wherein the haloarylpyrazole is applied in an initial dose of 4 mg/kg bodyweight of the animal, followed by weekly administration of doses of 2 mg/kg bodyweight of the animal.

8) A method for deterring ticks from infesting an animal, wherein the method comprises orally administering an initial dose of 4 mg of 5-chloro-1-(2,6-dichloro-4-trifluoromethylphenyl)-4-(4,5-dicyano-1H-imidazol-2-yl-3-methyl-1-H pyrazole per kg bodyweight of the animal, followed by weekly oral administration of 2 mg doses of 5-chloro-1-(2,6-dichloro-4-trifluoromethylphenyl)-4-(4,5-dicyano-1H-imidazol-2-yl-3-methyl-1H pyrazole per kg bodyweight of the animal.

9) The method according to claim 8, wherein 5-chloro-1-(2,6-dichloro-4-trifluoromethylphenyl)-4-(4,5-dicyano-1H-imidazol-2-yl-3-methyl-1-H pyrazole is administered as a tablet.

10) The method according to claim 8, wherein the animal is a dog.

11) The method according to claim 2, wherein the 5-chloro-1-(2,6-dichloro-4-trifluoromethylphenyl)-4-(4,5-dicyano-1H-imidazol-2-yl-3-methyl-1-H pyrazole is applied systemically to the animal.

12) The method according to claim 11, wherein the 5-chloro-1-(2,6-dichloro-4-trifluoromethylphenyl)-4-(4,5-dicyano-1H-imidazol-2-yl-3-methyl-1-H pyrazole is applied orally to the animal.

13) The method according to claim 2, wherein the animal is a dog or cat.

14) The method according to claim 2, wherein the 5-chloro-1-(2,6-dichloro-4-trifluoromethylphenyl)-4-(4,5-dicyano-1H-imidazol-2-yl-3-methyl-1-H pyrazole is applied in an initial dose of 4 mg/kg bodyweight of the animal, followed by weekly administration of doses of 2 mg/kg bodyweight of the animal.

15) The method according to claim 3, wherein the animal is a dog or cat.

16) The method according to claim 3, wherein the haloarylpyrazole is applied in an initial dose of 4 mg/kg bodyweight of the animal, followed by weekly administration of doses of 2 mg/kg bodyweight of the animal.

17) The method according to claim 4, wherein the animal is a dog or cat.

18) The method according to claim 5, wherein the animal is a dog or cat.

19) The method according to claim 9, wherein the animal is a dog.

20) A use of a haloarylpyrazole for making a medicament to deter ticks from infesting an animal, wherein:
the haloarylpyrazole corresponds in structure to formula (I): 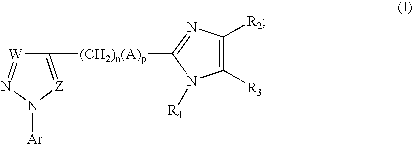
Ar is 2,6-dichloro-4-trifluoromethylphenyl or 2-nitro-4-trifluoromethylphenyl;
A is S(O)ₘ, CH═CH, O, or NH;
as to W and Z:
W is N, and Z is CR⁵; or
W is CR¹, and Z is N or CR⁵;
R¹ is hydrogen, optionally substituted alkyl, halogen, or R²⁰S(O)_{q};
R² and R³ are hydrogen, optionally substituted alkyl, optionally substituted alkenyl, optionally substituted alkynyl, aryl, cyano, halogen, nitro, YR²⁰, S(O)₂NR⁸R⁹, CHO, NR⁸R⁹, or CYNR⁸R⁹;
R⁴ is hydrogen, optionally substituted alkyl, optionally substituted alkenyl, acyl, or optionally substituted alkoxycarbonyl;
R⁵ is hydrogen, alkyl, optionally substituted amino, or halogen;
R⁸ and R⁹ are independently hydrogen, optionally substituted alkyl, acyl, or aryl;
R²⁰ is optionally substituted alkyl;
Y is O or S;
m is zero, 1, or 2;
p is zero or 1;
n is zero, 1, or 2;
q is zero, 1, or 2;
any alkyl, alkoxy, or alkylthio comprises 1 to 4 carbon atoms;
any alkenyl or alkynyl comprises 2 to 5 carbon atoms;
any alkyl, alkoxy, alkylthio, alkenyl, or alkynyl portion of a substituted alkyl, alkoxy, alkylthio, alkenyl, or alkynyl is substituted by one or more substituents independently selected from the group consisting of halogen, YR²⁰, dihalocyclopropyl, cyano, nitro, optionally substituted amino, acyloxy, and aryl;
any aryl is phenyl optionally substituted by halogen, alkyl, haloalkyl, alkoxy, haloalkoxy, alkylthio, haloalkylthio, haloalkylsulphonyl, cyano, or nitro;
any acyl is alkanoyl comprising 1 to 4 carbon atoms, alkylsulphonyl, or haloalkylsulphonyl;
any optionally substituted amino is NR⁸R⁹; and
R⁴ is not alkyl when:
W is CR¹,
Z is CR⁵, and
n and p are both zero.
